(19) United States
(12) Patent Application Publication
(10) Pub. No.: US 2017/0011391 A1
(43) Pub. Date: Jan. 12, 2017

(54) Method and apparatus for mobile payment

(71) Applicants: Liang Seng Koh, Fremont, CA (US); Hsin Pan, Fremont, CA (US); Futong Cho, Milpitas, CA (US); Fuliang Cho, San Jose, CA (US)

(72) Inventors: Liang Seng Koh, Fremont, CA (US); Hsin Pan, Fremont, CA (US); Futong Cho, Milpitas, CA (US); Fuliang Cho, San Jose, CA (US)

(73) Assignee: RFCyber Corp., Fremont, CA (US)

(21) Appl. No.: 15/271,225

(22) Filed: Sep. 21, 2016

Related U.S. Application Data
(63) Continuation-in-part of application No. 11/739,044, filed on Apr. 23, 2007.
Application No. 11/739,044 is a continuation-in-part of application No. 11/534,653, filed on Sep. 24, 2006, now Pat. No. 8,118,218.

(51) Int. Cl. G06Q 20/36; G06Q 30/04; G06Q 20/38; G06Q 20/32; G06Q 20/10; G06Q 20/20; G06Q 20/40

(52) U.S. Cl. CPC G06Q 20/3674; G06Q 20/204; G06Q 30/04; G06Q 20/4014; G06Q 20/3278; G06Q 20/102; G06Q 20/206; G06Q 20/3829

(57) ABSTRACT

Techniques for portable devices functioning as an electronic purchaser (e.g., e-purse) and/or an electronic mobile seller (e.g., mobile point-of-sales (POS)) are disclosed. According to one aspect of the invention, a mechanism is provided to enable a portable device to conduct e-commerce and m-commerce transactions over an open network with a payment server and/or a POS transaction server without compromising security. In one embodiment, a portable device is loaded with an e-purse as an electronic mobile purchaser. In another embodiment, the portable device is installed with a mobile POS as an electronic mobile seller.

### CROSS-REFERENCE TO RELATED APPLICATIONS

This application is a continuation of co-pending U.S. patent application Ser. No. 11/739,044, filed on Apr. 23, 2007, which is a continuation-in-part of co-pending U.S. patent application Ser. No. 11/534,653, filed on Sep. 24, 2006, now U.S. Pat. No. 8,118,218 issued on Feb. 21, 2012.

### BACKGROUND

Technical Field

The present invention is generally related to commerce over networks. Particularly, the present invention is related to electronic purses and mobile point-of-sales (POS) that can be advantageously used in portable devices for both electronic commerce (a.k.a., e-commerce) and mobile commerce (a.k.a., m-commerce).

Description of the Related Art

Single functional cards have been successfully used in enclosed environments such as transportation systems. One example of such single functional cards is MIFARE that is the most widely installed contactless smart card technology in the world. With more than 500 million smart card ICs and 5 million reader components sold, MIFARE has been selected as the most successful contactless smart card technology. MIFARE is the perfect solution for applications like loyalty and vending cards, road tolling, city cards, access control and gaming.

However, single functional card applications are deployed in enclosed systems, which are difficult to be expanded into other areas such as e-commerce and m-commerce because stored values and transaction information are stored in data storage of each tag that is protected by a set of keys. The nature of the tag is that the keys need to be delivered to the card for authentication before any data can be accessed during a transaction. This constraint makes systems using such technology difficult to be expanded to an open environment such as the Internet for e-commerce and/or cellular communications networks for m-commerce as the delivery of keys over a public domain network would cause security concerns.

There is, thus, a need for a mechanism in devices, especially portable devices, functioning as an electronic purchaser and/or an electronic seller to conduct transactions over an open network with a payment server and/or a POS transaction server without compromising security.

### BRIEF SUMMARY OF THE INVENTION

This section is for the purpose of summarizing some aspects of embodiments of the present invention and to briefly introduce some preferred embodiments. Simplifications or omissions in this section as well as the title and the abstract of this disclosure may be made to avoid obscuring the purpose of the section, the title and the abstract. Such simplifications or omissions are not intended to limit the scope of the present invention.

Broadly speaking, the invention is related to a mechanism provided to devices, especially portable devices, functioning as an electronic purchaser (e.g., electronic purse (e-purse)) and/or an electronic mobile seller (e.g., mobile POS) to be able to conduct transactions over an open network with a payment server and/or a POS transaction server without compromising security. According to one aspect of the present invention, a portable device (e.g., a cell phone, a personal digital assistant (PDA), etc.) is loaded with an e-purse manager. The e-purse manager is configured to manage various transactions and functions as a mechanism to access an emulator therein. The transactions may be conducted over a public domain network and/or a cellular communications network.

According to another aspect of the present invention, a three-tier security model is proposed, based on which the present invention is contemplated to operate. The three-tier security model includes a physical security, an e-purse security and a card manager security, concentrically encapsulating one with another. Security keys (either symmetric or asymmetric) are personalized within the three-tier security model so as to personalize an e-purse and perform secured transaction with a payment server. In one embodiment, the essential data to be personalized into an e-purse include one or more operation keys (e.g., a load or top-up key and a purchase key), default personal identification numbers (PINs), administration keys (e.g., an unblock PIN key and a reload PIN key), and passwords (e.g., from a service provider such as Mifare). During a transaction, the security keys are used to establish a secured channel between an embedded e-purse and a Security Authentication Module (SAM) or backend server in a financial institute (e.g., bank, credit union, credit clearing bureau, etc.).

According to yet another aspect of the present invention, a portable device with a service manager installed or pre-installed thereon is configured to securely download and install various service/application components (e.g., application MIDlets and application applets) from one or more service servers (e.g., service providers) over a cellular communications network (e.g., General Packet Radio Service (GPRS) network). Depending on implementation, some or all of the application MIDlets (e.g., POS manager, e-purse manager, etc.) are installed onto a baseband (e.g., memory space associated with microprocessor circuitry) of the portable device. The application applets are installed onto a secured element (e.g., a smart card) of the portable device, and further configured with personalized security keys (e.g., transformed keys, PINs) and other personalized information.

Furthermore, the service manager may also be pre-installed on a computer (e.g., a laptop, a desktop personal computer), or implemented as an online application (e.g., a web-based application). Together with a contactless reader (e.g., an ISO 14443 complied proximity coupling device, an ISO 15693 priximity reader), the installation and personalization described herein can then be conducted over a wired and/or wireless network (e.g., Internet).

According to yet another aspect of the present invention, a portable device is configured to conduct e-commerce and/or m-commerce as an electronic mobile seller (e.g., mobile POS). E-commerce and m-commerce operations (i.e., offline payment, online payment, real time top-up, virtual top-up, batch transactions upload, and various queries of balances and transactions) can be conducted using the portable device with a POS manager and a POS SAM installed therein.

Offline payment allows the portable device to collect an e-token from another e-token enabled device (e.g., a single functional card, Mifare, an e-purse enabled portable device, etc.) without connecting to a backend POS server. Real-time top-up allows the portable device to replenish e-tokens to another e-token enabled device in real time from a financial institute. Virtual top-up allows the portable device to replenish e-tokens to an e-token enabled device configured to only receive e-tokens from a funding account set up by a sponsor or donor. Batch transaction uploading allows accumulated POS transactions to be transmitted to a backend POS transaction server for settlement. Queries to the transaction and balance history are enabled with a MIDIet (e.g., a graphical user interface with built-in queries). All of the applications are secured in accordance with e-commerce and/or m-commerce industry standards.

The invention may be implemented in numerous ways, including a method, system, and device. In one embodiment, the present invention is a method for enabling a portable device to conduct mobile commerce transactions, the method comprises at least the following: installing a mobile commerce transaction module onto a secured element coupled to a baseband of the portable device; personalizing the installed mobile commerce transaction module; downloading a mobile commerce transaction manager module onto the baseband of the portable device based on personalized information from the personalized mobile commerce transaction module; and pre-installing a service manager module configured to facilitate said installing, said personalizing and said downloading steps. The personalization further comprises connecting to a personalization server at a service provider to establish a secured channel; sending a personalization request to the personalization server; receiving one or more network messages containing an personalization data array from the personalization server; and forwarding the personalization data array to the e-commerce and m-commerce transaction module.

According to another embodiment, the present invention is a system for system for conducting mobile commerce transactions, the system comprises at least the following: a portable device configured to be a mobile point-of-sales (POS) including a POS manager and a POS security authentication module (SAM) installed and personalized thereon and an e-token enabled device, wherein e-token is configured to be read by an contactless interface of the portable device, wherein the contactless interface is a complied proximity coupling device. The system further comprises a POS transaction server coupling to the POS manager via a secured channel over a cellular communications network.

According to yet another embodiment, the present invention is a method for conducting mobile commerce transactions using a portable device, the method comprises at least the following: retrieving an e-token by reading an e-token enabled device from a holder desirous of making a purchase transaction; determining whether the retrieved e-token is valid using a point-of-sales security authentication module (POS SAM) installed on the portable device; and recording the purchase transaction in the POS SAM by debiting the e-token if the e-token is determined to be valid and has enough balance to cover purchase amount, otherwise the purchase transaction is denied. The method further comprises uploading accumulated transactions in the POS SAM to a POS transaction server over either a cellular communications network or a public domain network and funding the e-token enabled device from a financial institute or a linked account via a POS manager of the portable device.

Accordingly one of the objects of the present inventions is to provide a mechanism to be embedded in devices, especially portable devices, to function as an electronic purchaser and/or an electronic mobile seller to conduct transactions over an open network with a payment server and/or a POS transaction server without compromising security.

Other objects, features, and advantages of the present invention will become apparent upon examining the following detailed description of an embodiment thereof, taken in conjunction with the attached drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1A shows a three-tier security model based on which the present invention is contemplated to operate according to one embodiment thereof;

FIG. 1B shows a data flow in accordance with the three-tier security model among three entities;

FIG. 2 shows an exemplary architecture diagram of a portable device enabled as an e-purse conducting e-commerce and m-commerce, according to one embodiment of the present invention;

FIG. 3A a block diagram of related modules interacting with each other to achieve what is referred to herein as e-purse personalization by an authorized personnel;

FIG. 3B shows a block diagram of related modules interacting with each other to achieve what is referred to herein as e-purse personalization by a user of the e-purse;

FIG. 3C shows a flowchart or process of personalizing an e-purse according to one embodiment of the present invention;

FIG. 4A and FIG. 4B show together a flowchart or process of financing, funding, load or top-up an e-purse according to one embodiment of the present invention;

FIG. 4C shows an exemplary block diagram of related blocks interacting with each other to achieve the process FIG. 4A and FIG. 4B;

FIG. 5A is a diagram showing a first exemplary architecture of a portable device for enabling e-commerce and m-commerce functionalities over a cellular communications network (i.e. GPRS network), according an embodiment of the present invention;

FIG. 5B is a diagram showing a second exemplary architecture of a portable device for enabling e-commerce and m-commerce functionalities over a wired and/or wireless data network (e.g., Internet), according another embodiment of the present invention;

FIG. 5C is a flowchart illustrating an exemplary process of enabling the portable device of FIG. 5A for services/applications provided by one or more service providers in accordance with one embodiment of the present invention;

FIG. 6A is a diagram showing an exemplary architecture, in which a portable device is enabled as a mobile POS conducting e-commerce and m-commerce, according to one embodiment of the present invention;

FIG. 6B is a diagram showing an exemplary architecture, in which a portable device is enabled as a mobile POS conducting a transaction upload operation over a network, according to an embodiment of the present invention;

FIG. 6C is a flowchart illustrating an exemplary process of conducting m-commerce using the portable device enabled as a mobile POS with an e-token enabled device as a single functional card in accordance with one embodiment of the present invention;

FIG. 6D is a flowchart illustrating an exemplary process of conducting m-commerce using the portable device enabled as a mobile POS against a an e-token enabled device as a multi-functional card; and

FIG. 7 is a diagram depicting an exemplary configuration in which a portable device used for an e-ticking application.

### DETAILED DESCRIPTION

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase in “one embodiment” in various places in the specification are not necessarily all referring to the same embodiment, nor are separate or alternative embodiments mutually exclusive of other embodiments. Further, the order of blocks in process, flowcharts or functional diagrams representing one or more embodiments do not inherently indicate any particular order nor imply limitations in the invention.

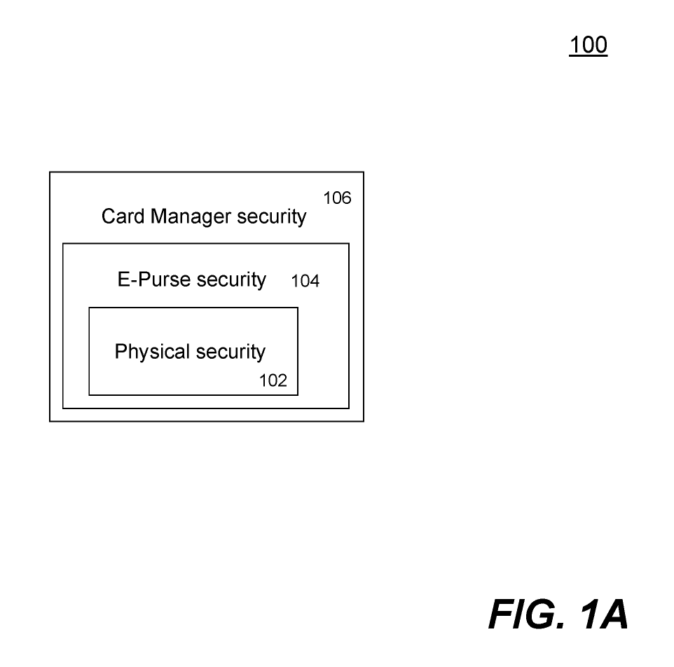

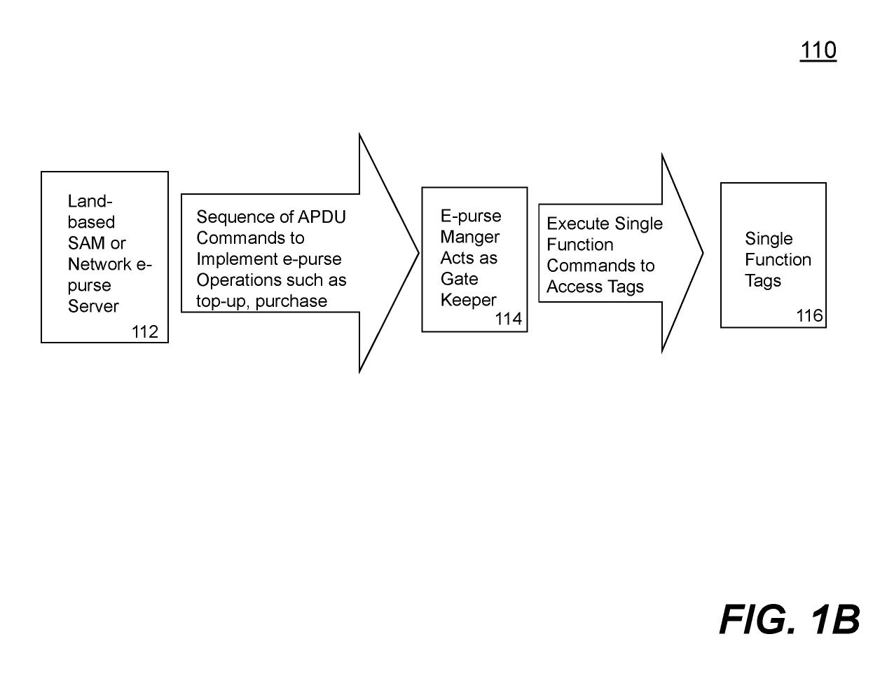

Embodiments of the present invention are discussed herein with reference to FIGS. 1A-7. However, those skilled in the art will readily appreciate that the detailed description given herein with respect to these figures is for explanatory purposes only as the invention extends beyond these limited embodiments.

FIG. 1A shows a three-tier security model 100 based on which the present invention is contemplated to operate according to one embodiment thereof. The three-tier security model 100 includes physical security 102, e-purse security 104 and card manager security 106.

Physical security 102 refers to a security mechanism provided by a single functional card to protect data stored on the card. The card may be hardware implemented or software emulated running on a type of media. Data on a single function card is protected by a set of access keys. These keys are configured onto the card when the card is issued. To avoid obscuring aspects of the present invention, the process of how the keys are configured onto the cards is omitted. For accessing the data, related keys are read by a contactless reader for authentication.

E-purse security 104 defines a set of protocols that enable micro payment transactions to be carried out in both wired and wireless environments. With an electronic purse (a.k.a., e-purse) stored on a smart card, a set of keys (either symmetric or asymmetric) is personalized into the e-purse when the e-purse is being issued. During a transaction, the e-purse uses a set of respective keys for encryption and Message Authentication Code (MAC) computation in order to establish and protect a secured channel between the e-purse and the SAM or backend servers. For a single functional card, the e-purse security 104 will act as a gate keeper to protect actual operations performed on a single functional card. During personalization, the single functional card access keys (or its transformation) are personalized into the e-purse with the e-purse transaction keys.

Card Manager Security 106, referring to a general security framework of a preload operating system in a smart card, provides a platform for PIN management and security channels (security domains) for card personalization. This platform via a card manager can be used to personalize an e-purse in one embodiment. One example of the card manager security 106 is what is referred to as a Global Platform (GP) that is a cross-industry membership organization created to advance standards for smart card growth. A GP combines the interests of smart card issuers, vendors, industry groups, public entities and technology companies to define requirements and technology standards for multiple application smart cards. In one embodiment, a global platform security is used to personalize a smart card. As a result, both e-purse keys and card access keys are personalized into a target tag.

FIG. 1B shows a data flow in accordance with the three-tier security model among three entities a land-based SAM or a network e-purse server 112, e-purse manager 114 acting as a gate keeper, and a single function tag 116. According to one embodiment of the present invention, communications between the land-based SAM or the network e-purse server 112 and the e-purse manager 114 are conducted in one type of commands (e.g., network messages) while communications between the e-purse manager 114 and the single function tag 116 are conducted in another type of commands (e.g., Application Protocol Data Unit (APDU)), wherein the e-purse manager 114 acts as the gate keeper to ensure only secured and authorized data transactions are allowed to happen.

In reference to FIG. 1A, the physical security is realized in an emulator. As used herein, an emulator means a hardware device or a program that pretends to be another particular device or program that other components expect to interact with. The e-purse security is realized between one or more applets configured to provide e-purse functioning and a payment server. The card manager security (e.g., global platform security) is realized via a card manager to update security keys to establish appropriate channels for interactions between the server and the applets, wherein the e-purse applet(s) acts as a gate keeper to regulate or control the data exchange.

According to one embodiment, a smart card has a preloaded smart card operation system that provides security framework to control the access to the smart card (e.g., an installation of external applications into the smart card). In order to manage the life cycle of an external application, a card manager module is configured by using the smart card security framework. For instance, a Java based smart card, SmartMX, is preloaded with an operating system JCOP 4.1. The Global Platform 2.1 installed on the SmartMX performs the card manager functionality.

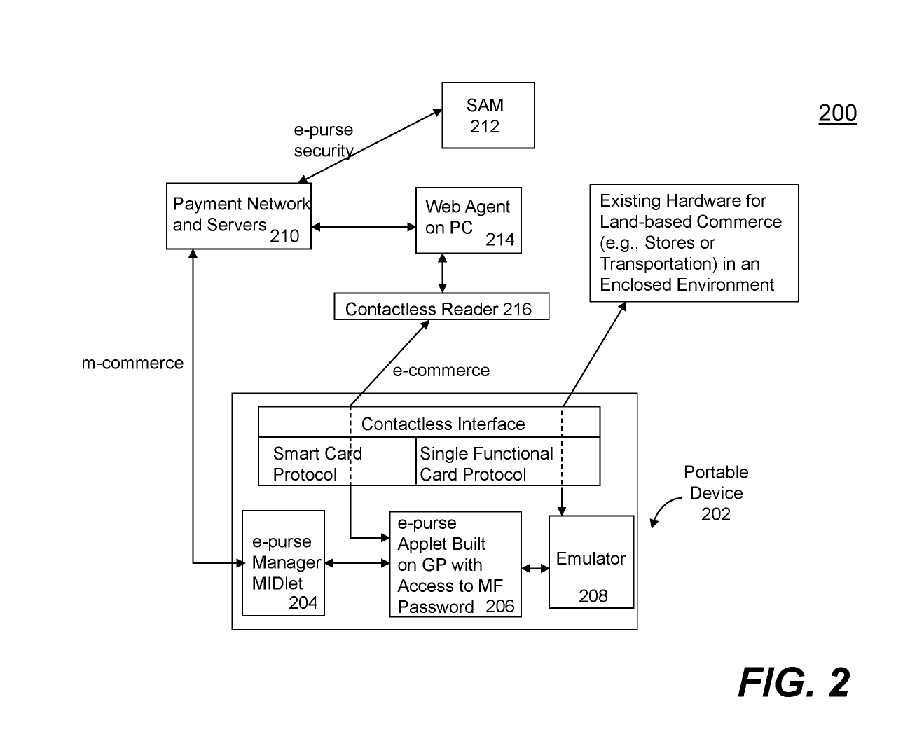

Referring now to FIG. 2, there shows an exemplary architecture diagram 200 of a portable device enabled as an e-purse conducting e-commerce and m-commerce, according to one embodiment of the present invention. The diagram 200 includes a cell phone 202 embedded with a smart card module. An example of such a cell phone is a near field communication (NFC) enabled cellphone that includes a Smart MX (SMX) module. The SMX is pre-loaded with a Mifare emulator 208 (which is a single functional card) for storing values. The cell phone is equipped with a contactless interface (e.g., ISO 14443 RFID) that allows the cell phone to act as a tag. In addition, the SMX is a JavaCard that can run Java applets. According to one embodiment, an e-purse is built on top of the global platform and implemented as an applet in SMX. The e-purse is configured to be able to access the Mifare data structures with appropriate transformed passwords based on the access keys.

In the cell phone 202, an e-purse manager MIDIet 204 is provided. For m-commerce, the MIDIet 204 acts as an agent to facilitate communications between an e-purse applet 206 and one or more payment network and servers 210 to conduct transactions therebetween. As used herein, a MIDIet is a software component suitable for being executed on a portable device. The e-purse manager MIDIet 204 is implemented as a “MIDIet” on a Java cell phone, or an “executable application” on a PDA device. One of the functions of the e-purse manager MIDIet 204 is to connect to a wireless network and communicate with an e-purse applet which can reside on either the same device or an external smart card. In addition, it is configured to provide administrative functions such as changing a PIN, viewing an e-purse balance and a transaction history log. In one application in which a card issuer provides a SAM 212 that is used to enable and authenticate any transactions between a card and a corresponding server (also referred to as a payment server). As shown in FIG. 2, APDU commands are constructed by the servers 210 having access to a SAM 212, where the APDU is a communication unit between a reader and a card. The structure of an APDU is defined by the ISO 7816 standards. Typically, an APDU command is embedded in network messages and delivered to the server 210 or the e-purse applet 206 for processing.

For e-commerce, a web agent 214 on a computer (not shown) is responsible for interacting with a contactless reader (e.g., an ISO 14443 RFID reader) and the network server 210. In operation, the agent 214 sends the APDU commands or receives responses thereto through the contactless reader 216 to/from the e-purse applet 206 residing in the cell phone 202. On the other hand, the agent 214 composes network requests (such as HTTP) and receives responses thereto from the payment server 210.

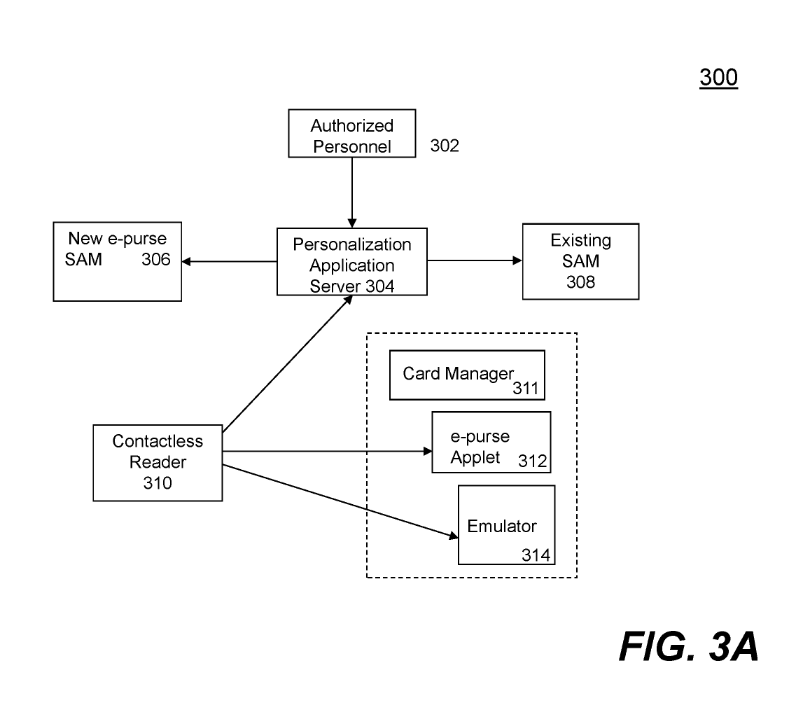

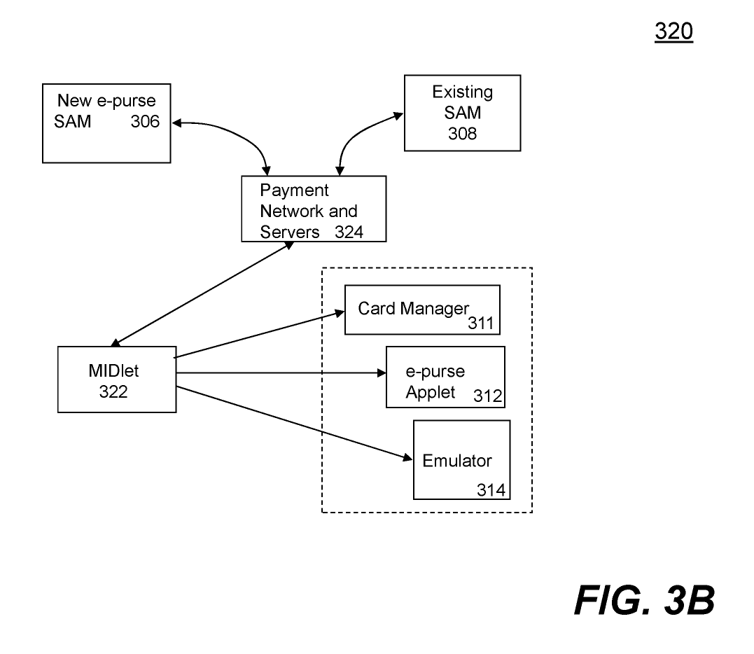

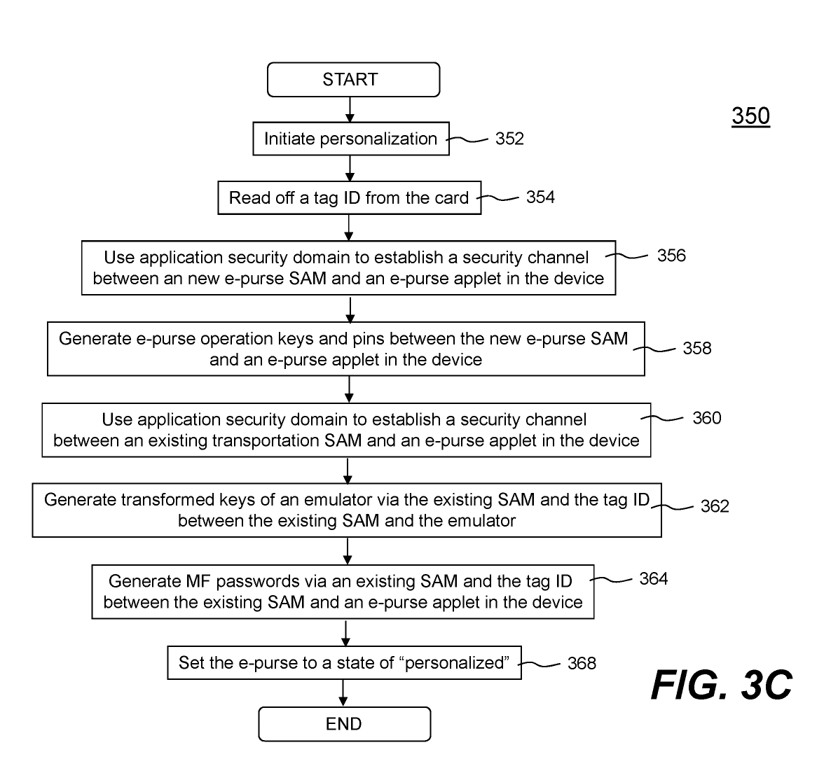

To personalize the cell phone 202, FIG. 3A shows a block diagram 300 of related modules interacting with each other to achieve what is referred to herein as e-purse personalization by an authorized person. FIG. 3B shows a block diagram 320 of related modules interacting with each other to achieve what is referred to herein as e-purse personalization by a user of the e-purse as shown in FIG. 2.

FIG. 3C shows a flowchart or process 350 of personalizing an e-purse applet according to one embodiment of the present invention. FIG. 3C is suggested to be understood in conjunction with FIG. 3A and FIG. 3B. The process 350 may be implemented in software, hardware or a combination of both.

As described above, an e-purse manager is built on top of a global platform to provide a security mechanism necessary to personalize e-purse applets designed therefor. In operation, a security domain is used for establishing a secured channel between a personalization application server and the e-purse applet. According to one embodiment, the essential data to be personalized into the e-purse applet include one or more operation keys (e.g., a load or top-up key and a purchase key), default PINs, administration keys (e.g., an unblock PIN key and a reload PIN key), and passwords (e.g., from Mifare).

It is assumed that a user desires to personalize an e-purse applet embedded in a portable device (e.g., a cell phone). At 352 of FIG. 3C, a personalization process is initiated. Depending on implementation, the personalization process may be implemented in a module in the portable device and activated manually or automatically, or a physical process initiated by an authorized person (typically associated with a card issuer). As shown in FIG. 3A, an authorized personal initiates a personalization process 304 to personalize the e-purse applet for a user thereof via an existing new e-purse SAM 306 and an existing SAM 308 with the contactless reader 310 as the interface. The card manager 311 performs at least two functions: 1) establishing a security channel, via a security domain, to install and personalize an external application (e.g., e-purse applet) in the card personalization; and 2) creating security means (e.g., PINs) to protect the application during subsequent operations. As a result of the personalization process using the personalization application server 304, the e-purse applet 312 and the emulator 314 are personalized.

Similarly, as shown in FIG. 3B, a user of an e-purse desires to initiate a personalization process to personalize the e-purse applet wirelessly (e.g., via the m-commerce path of FIG. 2). Different from FIG. 3A, FIG. 3B allows the personalization process to be activated manually or automatically. For example, there is a mechanism on a cell phone that, if pressed, activates the personalization process. Alternatively, a status of “non-personalized” may prompt to the user to start the personalization process. As described above, a MIDIet 322 (i.e., a service manager) in a portable device acts as an agent to facilitate the communication between a payment server 324 and the e-purse applet 312 as well as the emulator 314, wherein the payment server 324 has the access to the existing new e-purse SAM 306 and an existing SAM 308. As a result of the personalization process, the e-purse applet 312 and the emulator 314 are personalized.

Referring now back to FIG. 3C, after the personalization process is started, in view of FIG. 3A, the contactless reader 310 is activated to read the tag ID (i.e., RFID tag ID) and essential data from a smart card in the device at 354. With an application security domain (e.g., a default security setting by a card issuer), a security channel is then established at 356 between a new e-purse SAM (e.g., the SAM 306 of FIG. 3A) and an e-purse applet (e.g., the e-purse applet 312 of FIG. 3A) in the portable device.

Each application security domain of a global platform includes three (3) DES keys. For example:

Key1: 255/1/D ES-EC B/404142434445464748494a4b4c4d4e4f

Key2: 255/2/D ES-EC B/404142434445464748494a4b4c4d4e4f

Key3: 255/3/D ES-ECB/404142434445464748494a4b4c4d4e4f

A security domain is used to generate session keys for a secured session between two entities, such as the card manager applet and a host application, in which case the host application may be either a desktop personalization application or a networked personalization service provided by a backend server.

A default application domain can be installed by a card issuer and assigned to various application/service providers. The respective application owner can change the value of the key sets before the personalization process (or at the initial of the process). Then the application can use the new set to create a security channel for performing the personalization process.

With the security channel is established using the application provider's application security domain, the first set of data can be personalized to the e-purse applet. The second set of data can also be personalized with the same channel, too. However, if the data are in separate SAM, then a new security channel with the same key set (or different key sets) can be used to personalize the second set of data.

Via the new e-purse SAM 306, a set of e-purse operation keys and PINs are generated for data transactions between the new e-purse SAM and the e-purse applet to essentially personalize the e-purse applet at 358.

A second security channel is then established at 360 between an existing SAM (e.g., the SAM 308 of FIG. 3A) and the e-purse applet (e.g., the e-purse applet 312 of FIG. 3A) in the portable device. At 362, a set of transformed keys is generated using the existing SAM and the tag ID. The generated keys are stored in the emulator for subsequent data access authentication. At 358, a set of MF passwords is generated using the existing SAM and the tag ID, then is stored into the e-purse applet for future data access authentication. After it is done, the e-purse including the e-purse applet and the corresponding emulator is set to a state of “personalized”.

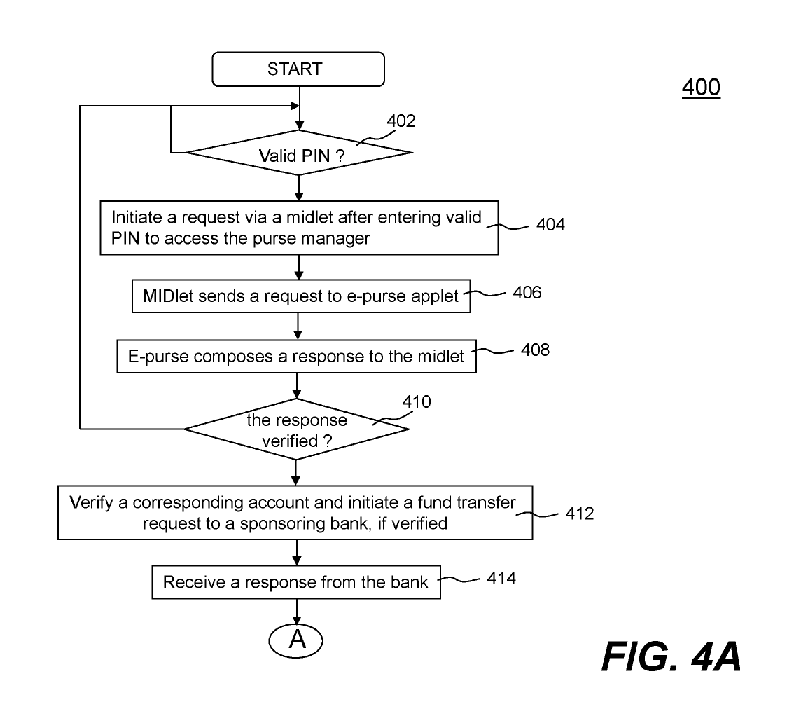

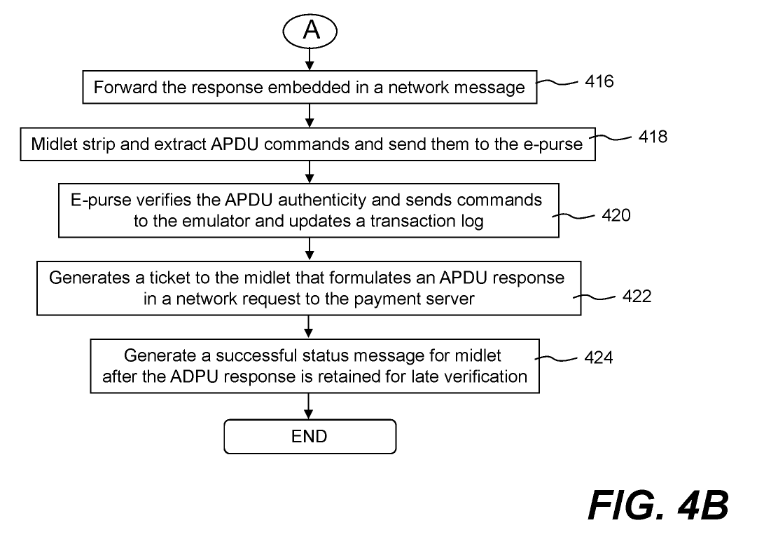

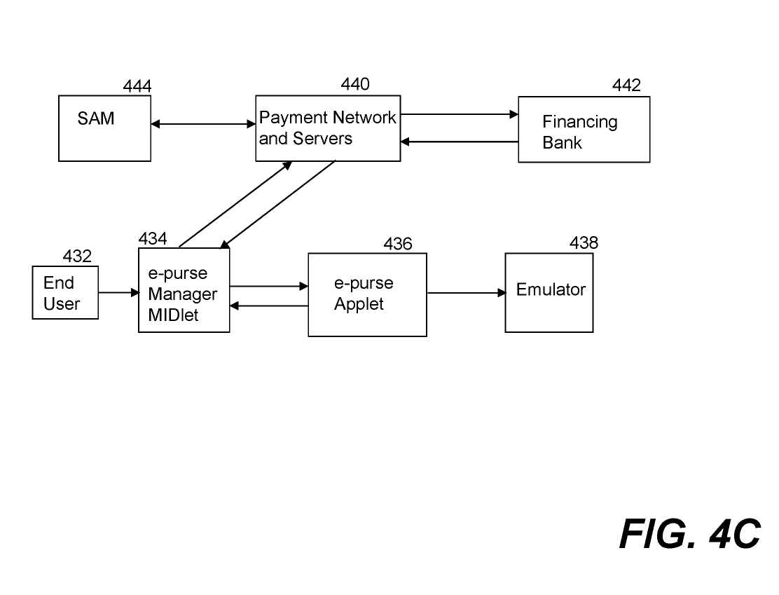

FIG. 4A and FIG. 4B show together a flowchart or process 400 of financing or funding an e-purse according to one embodiment of the present invention. The process 400 is conducted via the m-commerce path of FIG. 2. To better understand the process 400, FIG. 4C shows an exemplary block diagram 450 of related blocks interacting with each other to achieve the process 400. Depending on an actual application of the present invention, the process 400 may be implemented in software, hardware or a combination of both.

A user is assumed to have obtained a portable device (e.g., a cell phone) that is configured to include an e-purse. The user desires to fund the e-purse from an account associated with a bank. At 402, the user enters a set of personal identification numbers (PIN). Assuming the PIN is valid, an e-purse manger in the portable device is activated and initiates a request (also referred to an over-the-air (OTA) top-up request) at 404. The MIDIet in the portable device sends a request to the e-purse applet at 406, which is illustrated in FIG. 4C where the e-purse manager MIDIet 434 communicates with the e-purse applet 436.

At 408, the e-purse applet composes a response in responding to the request from the MIDIet. Upon receiving the response, the MIDIet sends the response to a payment network and server over a cellular communications network. As shown in FIG. 4C, the e-purse manager MIDIet 434 communicates with the e-purse applet 436 for a response that is then sent to the payment network and server 440. At 410, the process 400 needs to verify the validity of the response. If the response cannot be verified, the process 400 stops. If the response can be verified, the process 400 moves to 412 where a corresponding account at a bank is verified. If the account does exist, a fund transfer request is initiated. At 414, the bank receives the request and responds to the request by returning a response. In general, the messages exchanged between the payment network and server and the bank are compliant with a network protocol (e.g., HTTP for the Internet).

At 416, the response from the bank is transported to the payment network and server. The MIDIet strips and extracts the APDU commands from the response and forwards the commands to the e-purse applet at 418. The e-purse applet verifies the commands at 420 and, provided they are authorized, sends the commands to the emulator at 420 and, meanwhile updating a transaction log. At 422, a ticket is generated to formulate a response (e.g., in APDU format) for the payment server. As a result, the payment server is updated with a successful status message for the MIDIet, where the APDU response is retained for subsequent verification at 424.

As shown in FIG. 4C, the payment network and server 440 receives a response from the e-purse manager MIDIet 434 and verifies that the response is from an authorized e-purse applet 436 originally issued therefrom with a SAM 444. After the response is verified, the payment network and server 440 sends a request to the financing bank 442 with which the user 432 is assumed to maintain an account. The bank will verify the request, authorize the request, and return an authorization number in some pre-arranged message format. Upon receiving the response from the bank 442, the payment server 440 will either reject the request or accept the request by forming a network response sent to the MIDIet 434.

The e-purse manager 434 verifies the authenticity (e.g., in APDU format) and sends commands to the emulator 438 and updates the transaction logs. By now, the e-purse applet 436 finishes the necessary steps and returns a response to the MIDIet 434 that forwards an (APDU) response in a network request to the payment server 440.

Although the process 400 is described as funding the e-purse. Those skilled in the art can appreciate that the process of making purchasing over a network with the e-purse is substantially similar to the process 400, accordingly no separate discussion on the process of making purchasing is provided.

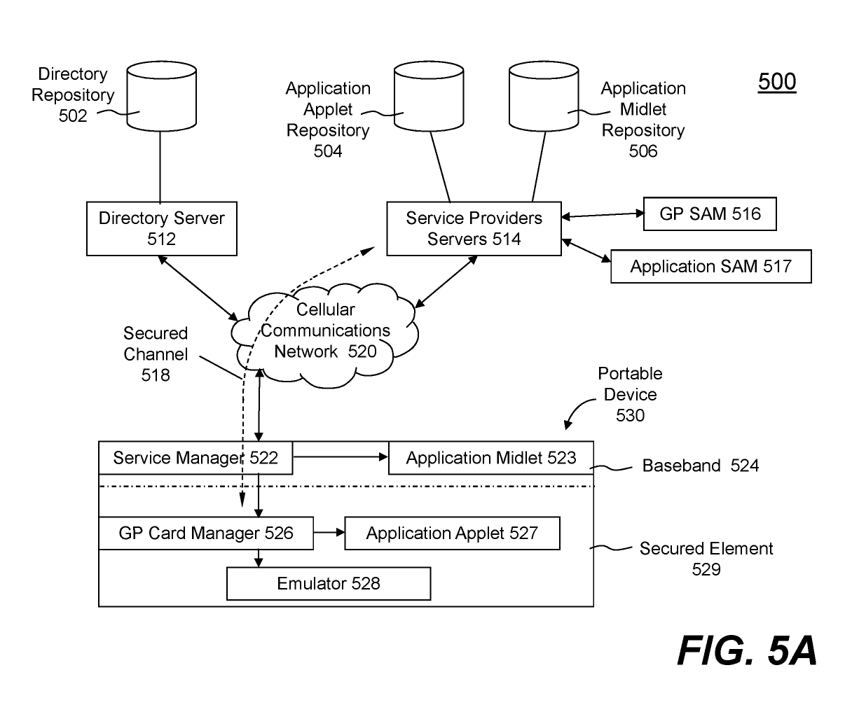

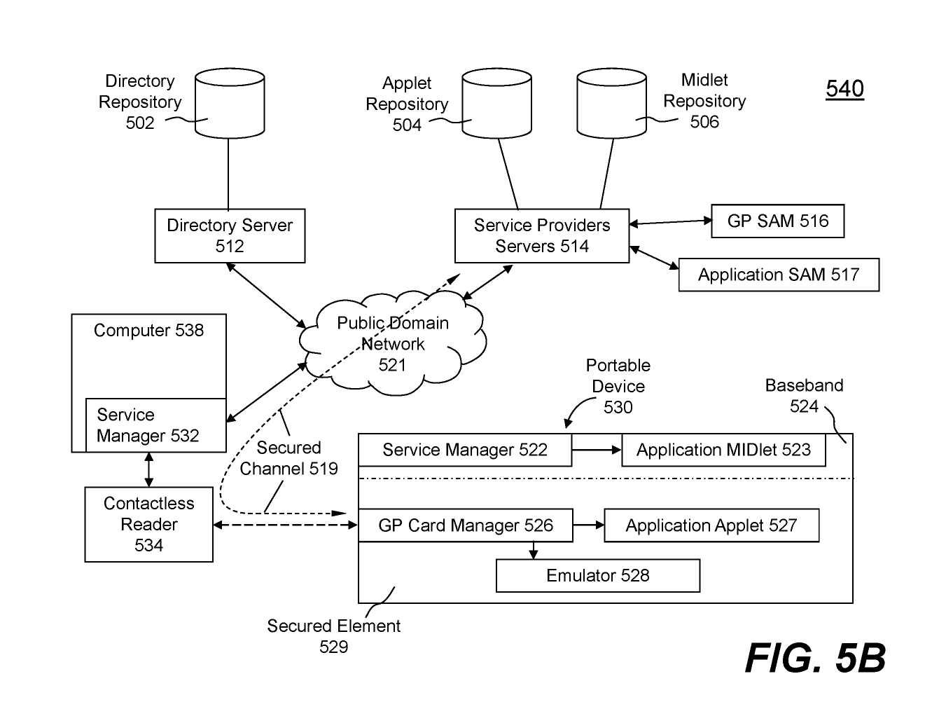

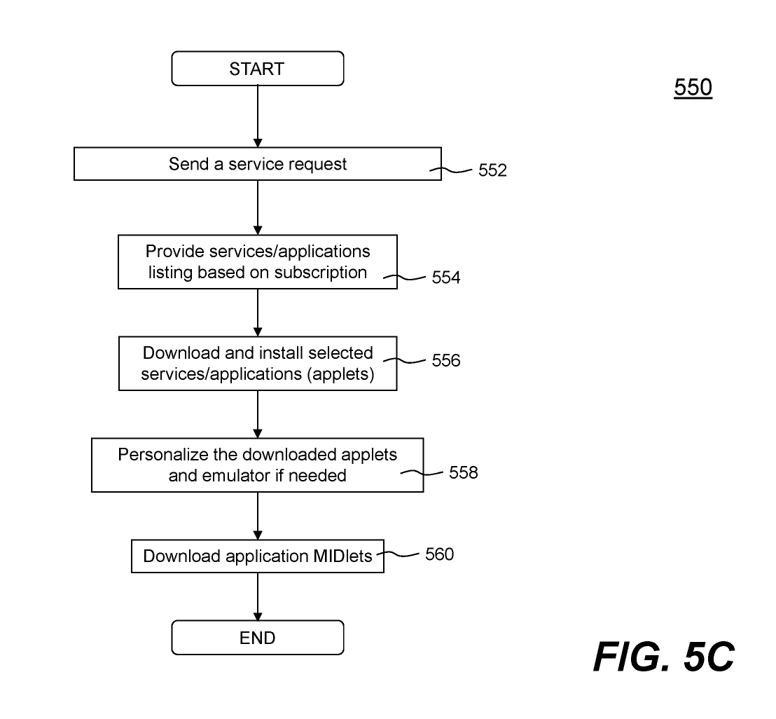

Referring to FIG. 5A, there is shown a first exemplary architecture 500 of enabling a portable device 530 for e-commerce and m-commerce over a cellular communications network 520 (e.g., a GPRS network) in accordance with one embodiment of the present invention. The portable device 530 comprises a baseband 524 and a secured element 529 (e.g., a smart card). One example of such portable device is a Near Field Communication (NFC) enabled portable device (e.g., a cell mobile phone or a PDA). The baseband 524 provides an electronic platform or environment (e.g., a Java Micro Edition (JME), or Mobile Information Device Profile (MIDP)), on which an application MIDIet 523 and a server manager 522 can be executed or run. The secured element 529 contains a Global Platform (GP) card manager 526, an emulator 528 and other components such as PIN manager (not shown).

To enable the portable device 530 to conduct e-commerce and m-commerce, one or more services/applications need to be pre-installed and pre-configured thereon. An instance of a service manager 522 (e.g., a MIDIet with GUI) needs to be activated. In one embodiment, the service manager 522 is downloaded and installed. In another embodiment, the service manager 522 is preloaded. In any case, once the service manager 522 is activated, a list of directories for various services is shown. The items in the list may be related to the subscription by a user, and may also include items in promotion independent of the subscription by the user. The directory list may be received from a directory repository 502 of a directory server 512. The directory server 512 acts as a central hub (i.e., yellow page functions) for different service providers (e.g., an installation server, a personalization server) that may choose to offer products and/or services to subscribers. The yellow page functions of the directory server 512 may include service plan information (e.g., service charge, start date, end date, etc.), installation, personalization and/or MIDIet download locations (e.g., Internet addresses). The installation and personalization may be provided by two different business entities. For example, the installation is provided by an issuer of a secured element 529, while the personalization may be provided by a service provider who holds application transaction keys for a particular application.

According to one embodiment, the service manager 522 is configured to connect to one or more servers 514 from service providers over the cellular communications network 520. It is assumed that the user has chosen one of the applications from the displayed directory. A secured channel 518 is established between the one or more servers 514 and the GP manager 526 to install/download an application applet 527 selected by the user and then to personalize the application applet 527 and optionally emulator 528, and finally to download an application MIDIet 523. The applet repository 504 and MIDIet repository 506 are the sources of generic application applets and application MIDlets, respectively. GP SAM 516 and application SAM 517 are used for creating the secured channel 518 for the personalization operations.

FIG. 5B is a diagram showing a second exemplary architecture 540 of enabling a portable device 530 for e-commerce and m-commerce over a public network 521, according to another embodiment of the present invention. Most of the components of the second architecture 540 are substantially similar to those of the first architecture 500 of FIG. 5A. While the first architecture 500 is based on operations over a cellular communications network 520, the public network 521 (e.g., Internet) is used in the second architecture 540. The public network 521 may include a local area network (LAN), a wide area network (WAN), a Wi-Fi (IEEE 802.11) wireless link, a Wi-Max (IEEE 802.16) wireless link, etc. In order to conduct service operations over the public network 521, an instance of the service manager 532 (i.e., same or similar functionality of the service manager MIDIet 522) is installed on a computer 538, which is coupled to the public network 521. The computer 538 may be a desktop personal computer (PC), a laptop PC, or other computing devices that can execute the instance of the service manager 532 and be connected to the public network 521. The connection between the computer 538 and the portable device 530 is through a contactless reader 534. The service manager 532 acts as an agent to facilitate the installation and personalization between one or more servers 514 of a service provider and a GP card manager 526 via a secured channel 519.

FIG. 5C is a flowchart illustrating a process 550 of enabling a portable device for e-commerce and m-commerce functionalities in accordance with one embodiment of the present invention. The process 550 may be implemented in software, hardware or a combination of both depending on implementation. To better understand the process 500, previous figures especially FIG. 5A and FIG. 5B are referred to in the following description.

Before the process 550 starts, an instance of a service manager 522 or 532 has been downloaded or pre-installed on either the portable device 530 or a computer 538. At 552, the service manager is activated and sends a service request to the server 514 at a service provider. Next after the authentication of a user and the portable device has been verified, at 554, the process 550 provides a directory list of services/applications based on subscription of the user of the portable device 530. For example, the list may contain a mobile POS application, an e-purse application, an e-ticketing application, and other commercially offered services. Then one of the services/applications is chosen from the directory list. For example, an e-purse or a mobile-POS may be chosen to configure the portable device 530. Responding to the user selection, the process 550 downloads and installs the selected services/applications at 556. For example, e-purse applet (i.e., application applet 527) is downloaded from the applet repository 504 and installed onto a secured element 529. The path for downloading or installation may be either via a secured channel 518 or 519. At 558, the process 550 personalizes the downloaded application applet and the emulator 528 if needed. Some of the downloaded application applets do not need to be personalized and some do. In one embodiment, a mobile POS application applet (“POS SAM”) needs to be personalized, and the following information or data array has to be provided:
a) a unique SAM ID based on the unique identifier of the underlying secured element;
b) a set of debit master keys;
c) a transformed message encryption key;
d) a transformed message authentication key;
e) a maximum length of remark for each offline transaction;
f) a transformed batch transaction key; and
g) a GP PIN.

In another embodiment, personalization of an e-purse applet for a single functional card not only needs to configure specific data (i.e., PINs, transformed keys, start date, end date, etc.) onto the e-purse, but also needs to configure the emulator to be operable in an open system. Finally, at 560, the process 550 downloads and optionally launches the application MIDIet 523. Some of the personalized data from the application applet may be accessed and displayed or provided from the user. The process 550 ends when all of the components of services/applications have been installed, personalized and downloaded.

According to one embodiment, an exemplary process of enabling a portable device 530 as a mobile POS is listed as follows:
a) connecting to an installation server (i.e., one of the service provider server 514) to request the server to establish a first security channel (e.g., the secured channel 518) from an issuer domain (i.e., applet repository 504) to the GP card manager 526 residing in a secured element 529;
b) receiving one or more network messages including APDU requests that envelop a POS SAM applet (e.g., a Java Cap file from the applet repository 504);
c) extracting the APDU requests from the received network messages;
d) sending the extracted APDU requests to the GP card manager 526 in a correct order for installation of the POS SAM (i.e., application applet 527) onto the secured element 529;
e) connecting to a personalization server (i.e., one of the service provider servers 514) for a second security channel (may or may not be the secured channel 518 depending on the server and/or the path) between the personalization server and the newly downloaded applet (i.e., POS SAM);
f) receiving one or more network messages for one or more separated ‘STORE DATA APDU’;
g) extracting and sending the ‘STORE DATA APDU’ to personalize POS SAM; and
h) downloading and launching POS manager (i.e., application MIDIet 523).

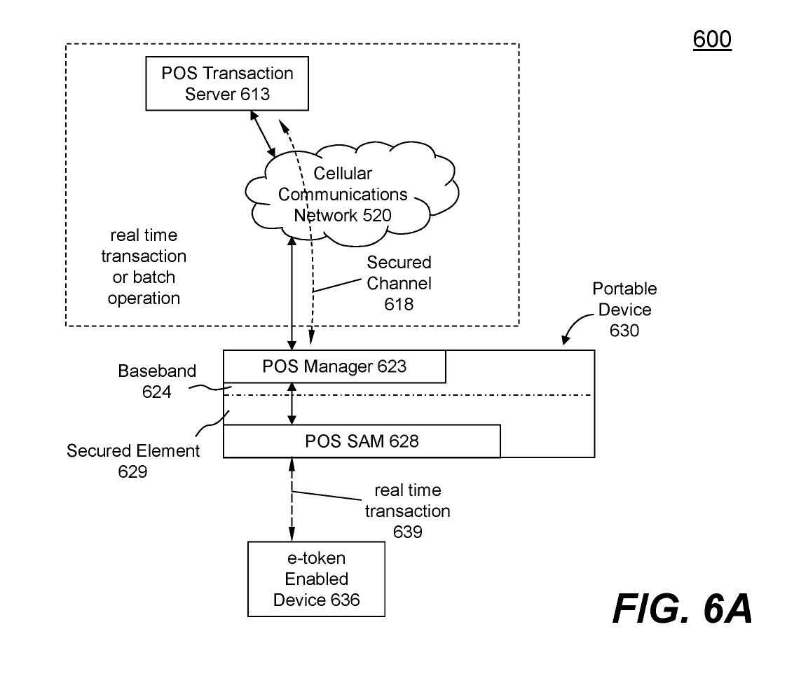

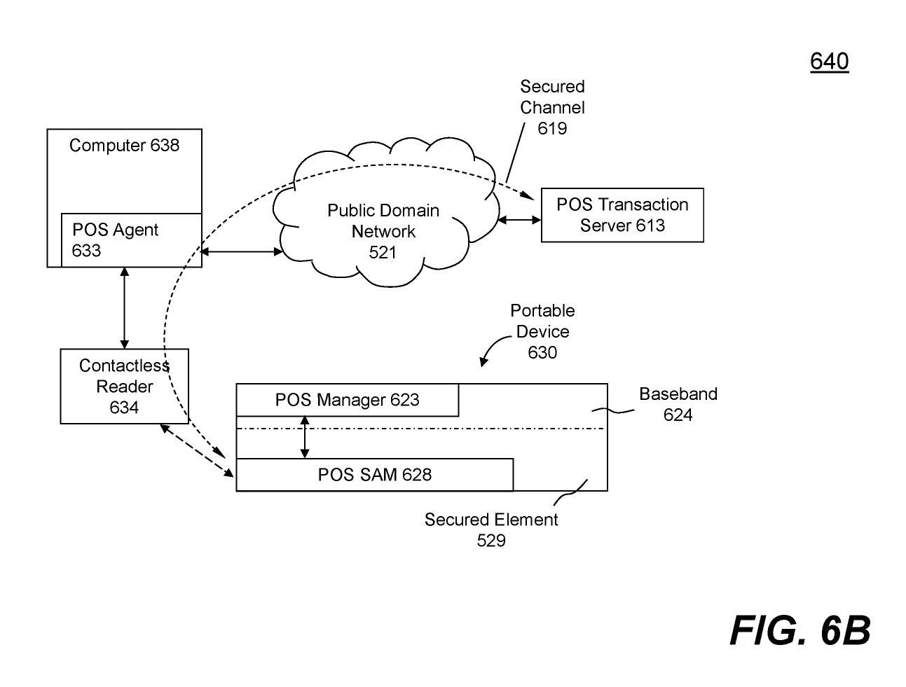

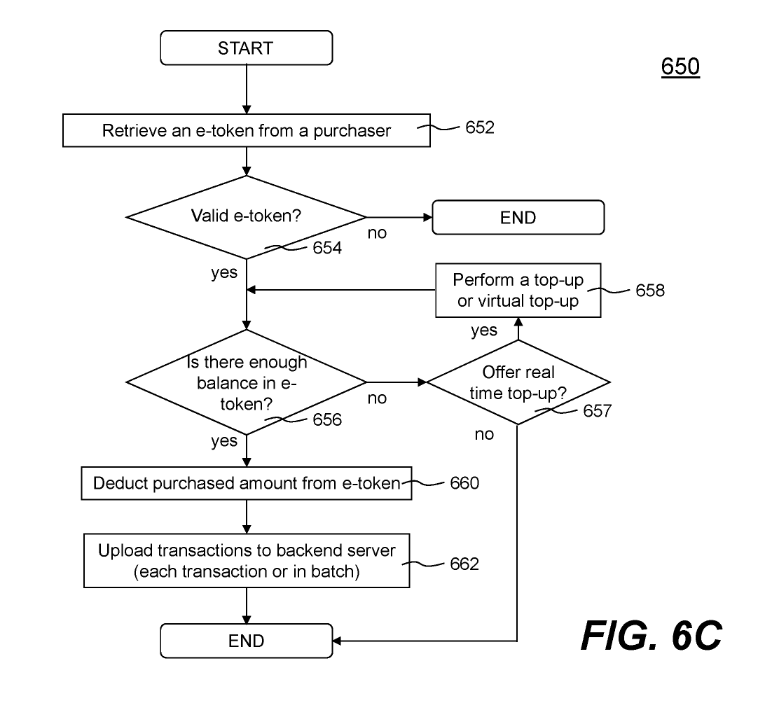

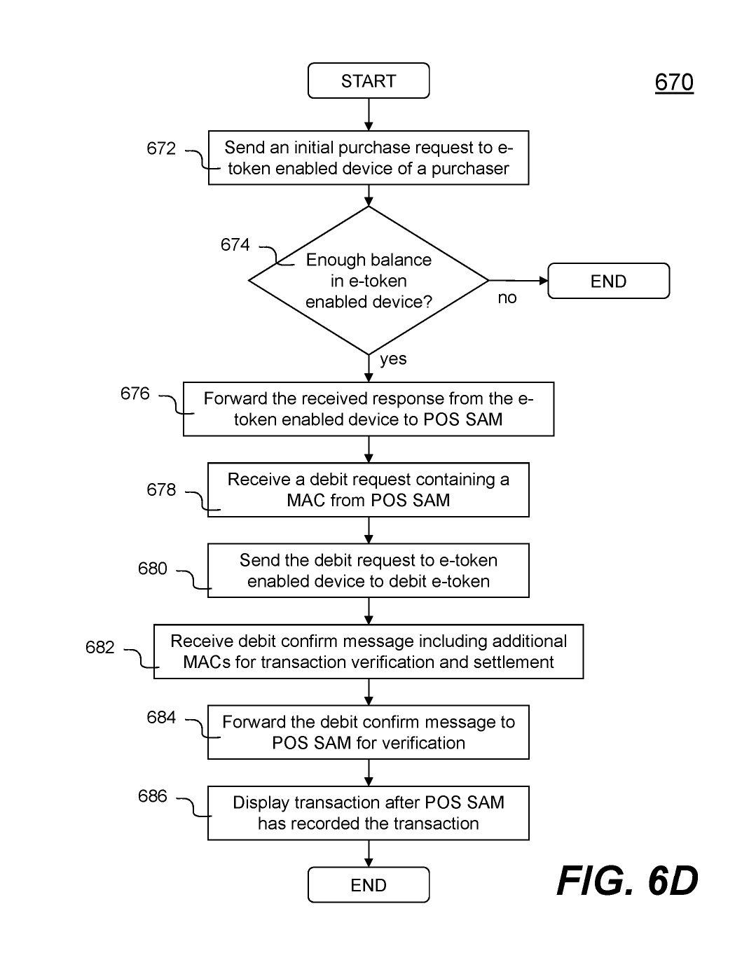

Referring to FIG. 6A, there is shown an exemplary architecture 600, in which a portable device 630 is enabled as a mobile POS to conduct e-commerce and m-commerce, according to one embodiment of the present invention. The portable device 630 comprises a baseband 624 and a secured element 629. A POS manager 623 is downloaded and installed in the baseband 623 and a POS SAM 628 is installed and personalized in the secured element 629 to enable the portable device 630 to act as a mobile POS. Then a real time transaction 639 can be conducted between the mobile POS enabled portable device 630 and an e-token enabled device 636 (e.g., a single functional card or a portable device enabled with an e-purse). The e-token may represent e-money, e-coupon, e-ticket, e-voucher or any other forms of payment tokens in a device.

The real time transaction 639 can be conducted offline (i.e., without the portable device connecting to a backend POS transaction server 613). However, the portable device 630 may connect to the backend POS transaction servers 613 over the cellular network 520 in certain instances, for example, the amount of the transaction is over a pre-defined threshold or limit, the e-token enabled device 636 needs a top-up or virtual top-up, transactional upload (single or in batch).

Records of accumulated offline transactions need to be uploaded to the backend POS transaction server 613 for settlement. The upload operations are conducted with the portable device 630 connecting to the POS transaction server 613 via a secured channel 618. Similar to the installation and personalization procedures, the upload operations can be conducted in two different routes: the cellular communications network 520, or the public network 521. The first route has been described and illustrated in FIG. 6A.

The second route is illustrated in FIG. 6B showing an exemplary architecture 640, in which a portable device 630 is enabled as a mobile POS conducting a transaction upload in batch operation over a public network 521, according to an embodiment of the present invention. Records of offline transactions in the mobile POS are generally kept and accumulated in a transaction log in the POS SAM 628. The transaction log are read by a contactless reader 634 into a POS agent 633 installed on a computer 638. The POS agent 633 then connects to a POS transaction server 613 over the public network 521 via a secured channel 619. Each of the upload operations is marked as a different batch, which includes one or more transaction records. Data communication between the POS SAM 628, the contactless reader 634 and the POS agent 632 in APDU containing the transaction records. Network messages that envelop the APDU (e.g., HTTP) are used between the POS agent 632 and the POS transaction server 613.

In one embodiment, an exemplary batch upload process from the POS manager 623 or the POS agent 633 includes:
a) sending a request to the POS SAM 628 to initiate a batch upload operation;
b) retrieving accumulated transaction records in form of APDU commands from a marked “batch” or “group” in the POS SAM 628 when the POS SAM 628 accepts the batch upload request;
c) forming one or more network messages containing the retrieved APDU commands;
d) sending the one or more network messages to the POS transaction server 613 via a secured channel 619;
e) receiving a acknowledgement signature from the POS transaction server 613; f) forwarding the acknowledgement signature in form APDU to the POS SAM 628 for verification and then deletion of the confirmed uploaded transaction records; and
g) repeating the step b) to step f) if there are additional un-uploaded transaction records still in the same “batch” or “group”.

Referring to FIG. 6C, there is shown a flowchart illustrating a process 650 of conducting m-commerce using the portable device 630 enabled to act as a mobile POS with an e-token enabled device 636 as a single functional card in accordance with one embodiment of the present invention. The process 650, which is preferably understood in conjunction with the previous figures especially FIG. 6A and FIG. 6B, may be implemented in software, hardware or a combination of both.

The process 650 (e.g., a process performed by the POS manager 623 of FIG. 6A) starts when a holder of an e-token enabled device (e.g., a Mifare card or an e-purse enabled cell phone emulating single functional card) desires to make a purchase or order a service with the mobile POS (i.e., the portable device 630). At 652, the portable device 630 retrieving an e-token (e.g., tag ID of Mifare card) by reading the e-token enabled device. Next, the process 650 verifies whether the retrieved e-token is valid at 654. If the e-token enabled device 636 of FIG. 6A is a single functional card (e.g., Mifare), the verification procedure performed by the POS manager 623 includes: i) reading the card identity (ID) of the card stored on an area that is unprotected or protected by a well-known key; ii) sending an APDU request containing the card ID to the POS SAM 628; iii) and receiving one or more transformed keys (e.g., for transaction counter, an issuer data, etc.) generated by the POS SAM 628. If the one or more received transformed keys are not valid, that is, the retrieved e-token being not valid, then the process 650 ends. Otherwise, the process 650 following the “yes” branch to 656, in which it is determined whether there is enough balance in the retrieved e-token to cover the cost of the current transaction. If the result is “no” at 656, the process 650 may optionally offer the holder to top-up (i.e., load, fund, finance) the e-token at 657. If “no”, the process 650 ends. Otherwise if the holder agrees to a real time top-up of the e-token enabled device, the process 650 performs either a top-up or a virtual top-up operation at 658. Then the process 650 goes back to 656. Whereas there is enough balance in the e-token, the process 650 deducts or debits the purchase amount from the e-token of the e-token enabled device 636 at 660. In the single functional card case, the one or more transformed keys are used to authorize the deduction. Finally at 662, records of one or more offline transactions accumulated in the POS SAM 628 are uploaded to the POS transaction server 613 for settlement. The upload operations may be conducted for each transaction or in batch over either the cellular communications network 520 or the public domain network 521.

The top-up operations have been described and shown in the process 400 of FIG. 4A. A virtual top-up operation is a special operation of the top-up operation and typically is used to credit an e-token by a sponsor or donor. To enable a virtual top-up operation, the sponsor needs to set up an account that ties to an e-token enabled device (e.g., a single functional card, a multi-functional card, an e-token enable cell phone, etc.). For example, an online account is offered by a commercial entity (e.g., business, bank, etc.). Once the sponsor has funded the e-token to the online account, the holder of the e-token enabled device is able to receive an e-token from the online account when connecting to the mobile POS. Various security measures are implemented to ensure the virtual top-up operation is secure and reliable. One exemplary usage of the virtual top-up is that a parent (i.e., a sponsor) can fund an e-token via an online account, which is linked to a cell phone (i.e., an e-token enabled device) of a child (i.e., the holder), such that the child may receive the funded e-token while the child makes a purchase at a mobile POS. In addition to various e-commerce and m-commerce functionalities described herein, the POS manager 623 is configured to provide various query operations, for example, a) checking the un-batched (i.e., not uploaded) balance accumulated in the POS SAM, b) listing the un-batched transaction log in the POS SAM, c) viewing details of a particular transaction stored in the POS SAM, d) checking the current balance of an e-token enabled device, e) listing a transaction log of the e-token enabled device, and f) viewing details of a particular transaction of the e-token enabled device.

Referring to FIG. 6D, there is shown a flowchart illustrating an exemplary process 670 of conducting m-commerce using the portable device 630 enabled to act as a mobile POS with an e-token enabled device 636 as a multi-functional card in accordance with one embodiment of the present invention. The process 670, which is preferably understood in conjunction with the previous figures especially FIG. 6A and FIG. 6B, may be implemented in software, hardware or a combination of both.

The process 670 (e.g., a process performed by the POS manager 623 of FIG. 6A) starts when a holder of an e-token enabled device 636 (e.g., a multi-functional card or an e-purse enabled cell phone emulating a multi-functional card) desires to make a purchase or order a service with the mobile POS (i.e., the portable device 630). At 672, the process 670 sends an initial purchase request to the e-token enabled device 636. The purchase amount is sent along with the initial request (e.g., APDU commands). Next the process 670 moves to decision 674. When there is not enough balance in the e-token enabled device 636. The initial purchase request will be turned down as a return message received at the POS manager 623. As a result, the process 670 ends with the purchase request being denied. If there is enough balance in the e-token enabled device 636, the result of the decision 674 is “yes” and the process 670 follows the “yes” branch to 676. The received response (e.g., APDU commands) from the e-token enabled device 636 is forwarded to the POS SAM 628. The response comprises information such as the version of the e-token key and a random number to be used for establishing a secured channel between the applet (e.g., e-purse applet) resided on the e-token enabled device 636 and the POS SAM 628 installed on the portable device 630. Then, at 678, the process 670 receives a debit request (e.g., APDU commands) generated by the POS SAM 628 in response to the forwarded response (i.e., the response at 676). The debit request contains a Message Authentication Code (MAC) for the applet (i.e., e-purse applet) to verify the upcoming debit operation, which is performed in response to the debit request sent at 680. The process 670 moves to 682 in which a confirmation message for the debit operation is received. In the confirmation message, there are additional MACs, which are used for verification and settlement by the POS SAM 628 and the POS transaction server 613, respectively. Next at 684, the debit confirmation message is forwarded to the POS SAM 628 for verification. Once the MAC is verified and the purchase transaction is recorded in the POS SAM 628, the recorded transaction is displayed at 686 before the process 670 ends. It is noted that the e-commerce transaction described may be carried out offline or online with the POS transaction server 613. Also when there is not enough balance in the e-token enabled device, a top-up or funding operation may be performed using the process 400 illustrated in FIG. 4A and FIG. 4B.

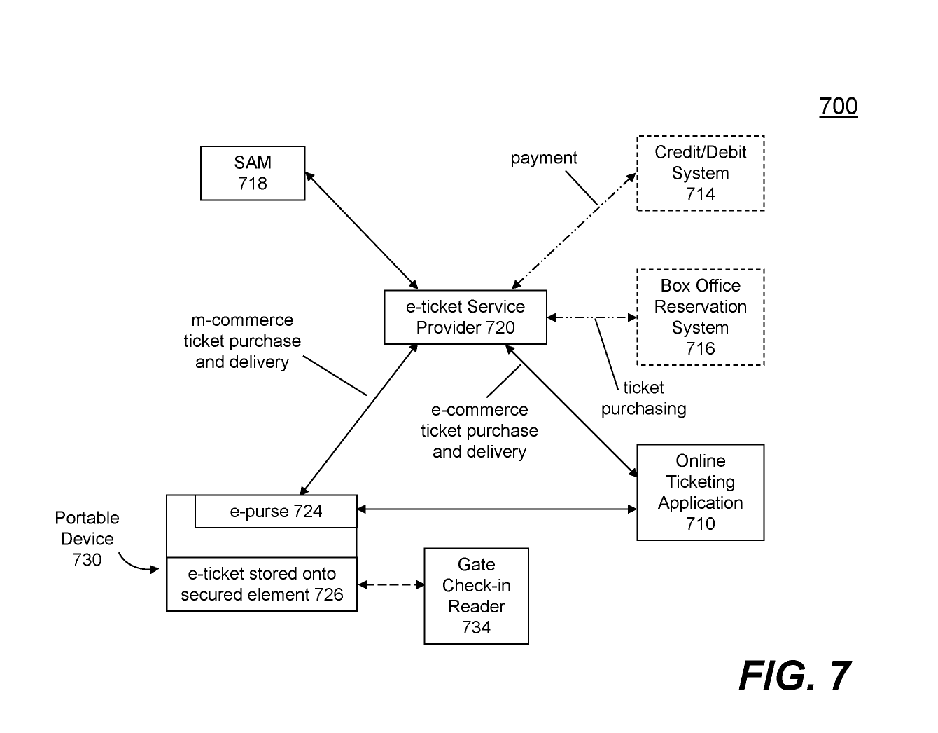

FIG. 7 shows an exemplary configuration in which a portable device is used for an e-ticketing application. A portable device 730 is configured to include an e-purse 724. When an owner or holder of the portable device 730 desires to purchase a ticket for a particular event (e.g., a concert ticket, a ballgame ticket, etc.), the owner can use e-purse 724 to purchase a ticket through an e-ticket service provider 720. The e-ticket service provider 720 may contact a traditional box office reservation system 716 or an online ticketing application 710 for ticket reservation and purchase. Then e-token (e.g., e-money) is deducted from the e-purse 724 of the portable device 730 to pay the ticket purchase to a credit/debit system 714 (e.g., a financial institute, a bank). A SAM 718 is connected to the e-ticket service provider 720 so that the authentication of e-purse 724 in the portable device 730 can be assured. Upon a confirmation of the payment is received, the e-ticket is delivered to the portable device 730 over the air (e.g., a cellular communications network) and stored onto a secured element 726 electronically, for example, an e-ticket code or key or password. Later on, when the owner of the portable device 730, the ticket holder, attends the particular event, the owner needs only to let a gate check-in reader 734 to read the stored e-ticket code or key in the portable device 730. In one embodiment, the gate check-in reader 734 is a contactless reader (e.g., an ISO 14443 complied proximity coupling device). The portable device 730 is an NFC capable mobile phone.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiment.

We claim:

1. A method for a portable device to conduct mobile commerce transactions, the method comprising:
verifying a mobile device has a sufficient resource to settle a transaction before a module is fully launched;
receiving in the mobile device an electronic invoice wirelessly from a point-of-sale (POS) terminal,
displaying the electronic invoice to a user of the mobile device;
facilitating the user to authorize the module to pay for an amount pertaining to the electronic invoice, wherein the mobile device is not needed to be online; and
receiving a response in the mobile device from the POS terminal after the amount is received by a merchant associated with the POS.

2. The method of claim 1, wherein the module is executed in a baseband of the portable device and has been personalized in advance.

3. The method of claim 2, wherein the mobile device is near field communication (NFC) enabled, and the method further comprising:
pre-installing the module in the mobile device; and
provisioning the module with a designated server when the mobile device is online.

4. The method of claim 3, wherein the mobile device includes a secure element, and wherein said provisioning the module further comprises:
determining whether the secure element has been personalized or not;
personalizing the secure element when the secure element has not been personalized.

5. The method of claim 4, wherein said personalizing the secure element further comprises
establishing a first secured channel between the mobile device and the designated server;
sending a personalization request to the designated server;
receiving one or more network messages containing an personalization data array from the designated server; and
storing some or all of the designated data array into the secure element.

6. The method of claim 5, wherein the personalization data array comprises transformed identification generated by the designated server using at least an unique ID of the secured element.

7. The method of claim 6, wherein the personalization data array further comprises various keys and codes.

8. The method of claim 7, wherein the personalization data array is formed with commands in accordance with Application Protocol Data Unit (APDU).

9. The method of claim 8, wherein said provisioning the module is performed with the personalized secure element.

10. The method of claim 1, wherein the mobile device is designed to be read wirelessly by an contactless interface of the POS terminal.

11. The method of claim 10, further comprising:
retrieving in the POS terminal an identifier of an e-token from the mobile device;
verifying whether the e-token is valid by:
reading an identity related to the e-token;
sending a request containing the identity to a third party for verification; and
receiving one or more transformed keys generated by the third party after the third party confirms the identity.

12. The method of claim 11, wherein the e-token is protected by at least a key in the mobile device.

13. The method of claim 11, wherein the e-token is funded via an account set up with a commercial entity.

14. The method of claim 1, wherein the mobile device keeps a log of transactions that are only uploaded to an account when the mobile device is back online.

15. The method of claim 1, wherein details of transactions are kept in the mobile device and viewed by the user whenever needed.
